(19) United States
(12) Patent Application Publication
(10) Pub. No.: US 2026/0156102 A1
(43) Pub. Date: Jun. 4, 2026

(54) Methods and systems for encrypted email transmission

(71) Applicant: Hanzhou Hualan Microelectronique Co., Ltd., Hangzhou (CN)

(72) Inventors: Jianjun LUO, Hangzhou (CN); Hang TAO, Hangzhou (CN); Wenkui WANG, Hangzhou (CN)

(73) Assignee: Hanzhou Hualan Microelectronique Co., Ltd., Hangzhou (CN)

(21) Appl. No.: 18/949,839

(22) Filed: Nov. 15, 2024

(30) Foreign Application Priority Data
Dec. 18, 2023 (CN) 202311748399.7
Dec. 19, 2023 (CN) 202311756896.1

(51) Int. Cl. H04L 9/40; H04L 51/00

(52) U.S. Cl. CPC H04L 63/0428; H04L 51/00

(57) ABSTRACT

Technique for encrypted email transmission using a pair of personal drivers/devices (e.g., USB drivers) are described. Each of the personal devices is loaded with or includes an encryption/decryption (a.k.a., cipher) engine that may be in form of software or hardware. When an email is authored, before it is sent out by a sender (first user), the email is routed to a personal device associated with the sender, where the email is encrypted. What an email application (e.g., Outlook or Gmail) sends out is the encrypted email. While in transit on a public network (e.g., the Internet) via an email server, the content in the email is fully protected through encryption. Upon receiving the email by a designated recipient (receiver), the encrypted email is caused to go through another personal device associated with the recipient, where the encrypted email is decrypted by a corresponding cipher engine therein. The content is then shown in an email application (e.g., Outlook or Gmail).

### FIELD

The subject matter described herein relates to the field of data communication or exchange, more particularly to methods and systems for encrypted email or e-mail transmission.

### BACKGROUND

As a very common tool for information transmission or exchange in modern society, email security is increasingly becoming a concern for users. Typically, to improve the security of emails during transmission, software is often used to encrypt the emails before they are sent over a public network such as the Internet.

However, software used for email encryption is often vulnerable to cyberattacks, which results in lower security during email transmission.

### SUMMARY

Techniques for encrypted email transmission, electronic devices, storage media, and systems are disclosed, which can solve problems of security vulnerability for email transmission.

According to one aspect of the present invention, a technique for encrypted email transmission using a pair of personal drivers/devices (e.g., USB drivers), where each of the personal devices is loaded with or includes an encryption/decryption (a.k.a., cipher) engine that may be in form of software or hardware. When an email is authored, before it is sent out by a sender (first user), the email is routed to a personal driver associated with the sender, where the email is encrypted. What an email application (e.g., Outlook or Gmail) sends out is the encrypted email. While in transit on a public network (e.g., the internet) via an email server, the content in the email is fully protected through encryption. Upon receiving the email by a designated recipient (receiver), the encrypted email is caused to go through another personal device associated with the receiver, where the encrypted email is decrypted by a corresponding cipher engine therein. The content is then shown in an email application (e.g., Outlook or Gmail).

According to another aspect of the present invention, an email server receives a first encrypted email sent by a first device, where the first encrypted email is encrypted in a personal device associated with the sender or using a private key from the sender. Upon receiving the encrypted email, the email server decrypts the first encrypted email using a mutually-agreed cipher engine or a public key of the sender in the mail server to generate a first decrypted email. The email server then encrypts the first decrypted email using a public key of the designated receiver to generate a second encrypted email. The email server sends/transmits the second encrypted email to a second electronic device associated with the receiver. A cipher engine associated with the receiver decrypts the second encrypted email. The content is then shown in an email application (e.g., Outlook or Gmail)

According to still another aspect of the present invention: this present invention provides a method for encrypted email transmission, the method includes: a mobile personal device generates a first encrypted email, wherein the encrypted email is generated by a cipher engine in the personal device. The encrypted email is transported over a public/private network and subsequently received by a recipient.

The present invention may be implemented in software, hardware or a combination of both. According to one embodiment, the present invention is a method for secured email transmission. The method comprises: generating an encrypted email in a first personal device, including a cipher engine therein, associated with a sender of an email, transporting the encrypted email over a network; and recovering the email from the encrypted email when the encrypted email is received, wherein the email is decrypted by a cipher engine in a second personal device associated with a recipient.

According to another embodiment, the present invention is a system for secured email transmission, the system comprising: a first personal device including a cipher engine provided to encrypt an email authorized by a sender when the email is ready to be transported over a network to a recipient, wherein the first personal device is associated with the sender, and a second personal device including a cipher engine provided to decrypt an encrypted email when the encrypted email is received from the network, wherein the second personal device is associated with the recipient. The system may also include a mail server receiving the encrypted email and routing the encrypted email to the recipient in accordance with an email address affixed to the encrypted email.

There are many other objects, together with the foregoing attained in the exercise of the invention in the following description and resulting in the embodiment illustrated in the accompanying drawings.

### DESCRIPTION OF DRAWINGS

These and other features, aspects, and advantages of the present invention will become better understood with regard to the following description, appended claims, and accompanying drawings wherein:

FIG. 1A shows a prior art example in which a sender sends an email to a recipient via a network;

FIG. 1B shows a systemic configuration according to one embodiment of the present invention, in which two computing devices, coupled to the network, are used to send/receive or simply exchange electronic information including email, documents and various data, where each of the computing devices is coupled to a personal device for encryption or decryption;

FIG. 1C is a process or flowchart of encrypted email transmission according to one embodiment;

FIG. 2 is a flowchart of a first example for encrypted email transmission according to one embodiment;

FIG. 3 is a flowchart of a second example for encrypted email transmission according to one embodiment;

FIG. 4 is a flowchart of a third example for encrypted email transmission according to one embodiment;

FIG. 5 is a flowchart of a fourth example for encrypted email transmission according to one embodiment;

FIG. 6 is a flowchart of a fifth example for encrypted email transmission according to one embodiment;

FIG. 7 is an exemplary structural block diagram of an encrypted email transmission system according to one embodiment;

FIG. 8 is an exemplary structural block diagram of an encrypted email transmission device according to one embodiment; and

FIG. 9 is an exemplary structural block diagram of an electronic device according to one embodiment.

### DETAILED DESCRIPTION

The following describes the technical solutions in the embodiments of this application in conjunction with the drawings. It is evident that the described embodiments are part of the present invention and not all of them. Based on these embodiments, all other embodiments that can be obtained by those skilled in the art without creative effort fall within the scope of protection of this application.

The terms “first,” “second,” etc., in this application's description and claims are used to distinguish similar objects and are not intended to describe specific orders or priorities. It should be understood that such terms can be interchanged in appropriate circumstances so that the embodiments of this application can be implemented in orders different from those illustrated or described here. The objects distinguished by “first” and “second” are generally of the same category and are not limited in number; for example, the “first” object can be one or multiple objects. Additionally, the terms “and/or” used in the specification and claims indicate that at least one of the connected objects is included, and the character “/” generally indicates an “or” relationship between the preceding and following objects.

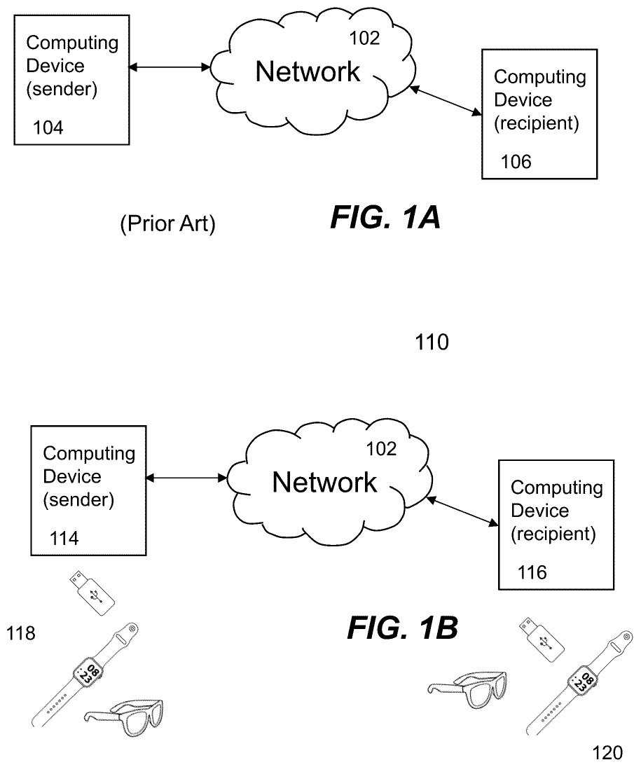

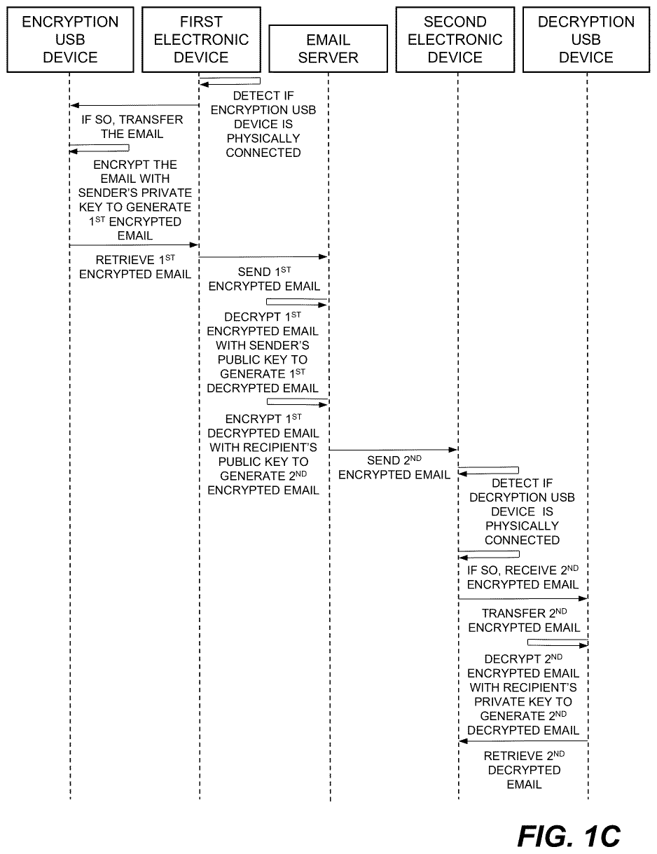

In general, email encryption is typically achieved through software, for example, using symmetric encryption algorithms (e.g., block cipher algorithms, stream cipher algorithms, and etc.) to generate encryption keys. FIG. 1A shows a corresponding example in which a sender sends an email to a recipient via a network 102. A computing device 104 used by the sender is installed with encryption keys from a software encryption algorithm. These encryption keys are then used to encrypt the email, enhancing security during transmission. Upon receiving the email by a recipient, the email is decrypted with a corresponding key at another computing device 106. However, the software in the devices 104 and 106 used to encrypt/decrypt emails is vulnerable to cyberattacks, leading to leakage of the encryption keys or even the email content itself, resulting in vulnerability or lower security during transmission.

FIG. 1B shows a systemic configuration 100 in which a computing device 114 or 116, coupled to the network 102, is used to send/receive or simply exchange electronic information including email, documents and various data. For simplicity, email will be used to describe various embodiments herein. An example of the computing device 114 or 116 may include, but not be limited to, a desktop/laptop computer or a smart device (e.g., phone, glasses, or watches). Each of the computing device 114 or 116 is coupled to a personal device 118 or 120. As the name suggests, the personal device is something not to be shared and can only be used by the owner thereof or under close supervision. Depending on implementation, the personal device may be a pluggable device (e.g., a USB drive) or a wearable device (e.g., Apple Watch or AR/VR glasses).

To facilitate the description of the present invention, a USB device as an example of the personal device 118 or 120 is used. According to one embodiment, an encryption USB (Universal Serial Bus) device (e.g., USB security key or USB token) is provided to couple to a first electronic device (e.g., the device 114) and used for encrypting an email from a sender to a recipient, and a decryption USB device (e.g., USB security key or USB token) coupled to a second electronic device (e.g., the device 116) is used for decrypting an encrypted email received. In the event, the personal device 118 is a wearable device other than a USB device, the communication between the wearable device and the computing device 114 or 116 may be via Bluetooth or other wireless communication. Those skilled in the art shall understand how to use/control the wireless communication to achieve what is being disclosed herein.

Referring now to FIG. 1C, it shows a process or flowchart of sending an encrypted email over a network. After a first electronic device receives an instruction or a computer command to encrypt and send an email, it detects whether there is an encryption USB device connected to the first electronic device. If the encryption USB device is connected, the email is transmitted to the encryption USB device. The encryption USB device encrypts the email with a private key of the sender, resulting in a first encrypted email. The first electronic device retrieves the first encrypted email from the encryption USB device and sends it to an email server (not shown). The email server decrypts and re-encrypts the email. Specifically, the email server decrypts the first encrypted email using a public key of the sender to recover the email in clear form (or a first decrypted email), then encrypts the first decrypted email using a public key of the recipient, resulting in a second encrypted email. The email server then sends the second encrypted email to a second electronic device associated with the recipient of the email. The second electronic device detects whether a decryption USB device is connected. If connected, the second electronic device receives the second encrypted email from the email server and transmits it to the decryption USB device. The decryption USB device decrypts the second encrypted email using a private key of the recipient, resulting in a second decrypted email (i.e., the original email). The second electronic device retrieves the second decrypted email from the decryption USB device and displays it to the recipient.

In one embodiment, before the encryption USB device performs the encryption operations on an email, the first electronic device transmits the email to the encryption USB device. After the first electronic device retrieves the first encrypted email from the encryption USB device, it sends the first encrypted email to the email server. The email server then processes the first encrypted email and sends it to the second electronic device associated with the recipient. This embodiment uses a dedicated email server to receive and decrypt the first encrypted email. The email server is also responsible for re-encrypting the email. Specifically, the email server decrypts the first encrypted email, resulting in a first decrypted email (i.e., the original email). The email server then encrypts the email again using, resulting in a second encrypted email which is then sent to the recipient via the second electronic device.

In one embodiment, the encryption USB device may be any USB security device that can receive the email and encrypt the email from the first electronic device. Correspondingly, during the process of receiving the email, the decryption USB device may be any USB security device that can receive the second encrypted email and decrypt the second encrypted email from the second electronic device.

In one embodiment, a USB security device can function both as an encryption USB system and a decryption USB device. Specifically, when connected to a registration server (i.e., an account or server that supports hardware-based authentication, e.g., email server, etc.), a USB security device can be registered through the registration server as an encryption USB device. Once successfully registered, the encryption USB device can obtain/generate multiple security keys from the registration server, including the sender's private key for encrypting/decrypting email. During the process of sending an email, a USB security device registered as an encryption USB device can encrypt the email by using one or more private keys of the sender to generate the first encrypted email. Similarly, when connected to a registration server, a USB security device can be registered as a decryption USB device. Upon successful registration, the decryption USB device can obtain/generate multiple security keys from the registration server, including one or more private keys for the second encrypted email. During the process of receiving an email, the USB security device registered as a decryption USB device can decrypt the second encrypted email using the private key of the recipient to generate the second decrypted email (i.e., the original email or content thereof).

In additional, typically, software used for encrypting and decrypting emails employs symmetric algorithms (e.g., block cipher, stream cipher, etc.) for generating security keys. The key generated through symmetric algorithm is used for encrypting an email, and the same key is used for decrypting the encrypted email. However, when email encryption based symmetric algorithm is under cyberattack, the keys from the symmetric algorithm may be compromised, thereby leaking the email. In one embodiment, when a USB security device is connected to and registered with a registration server, the USB device obtains/generates multiple security keys from the registration server, including private keys generated using asymmetric algorithms (e.g., Diffie-Hellman key exchange, Elliptic Curve Cryptography, and etc.). These security keys can be either the private key for a sender or private key for a recipient. Correspondingly, the email server stores public keys for the sender and recipient. After the encryption USB device encrypts an email using the private key of the sender to generate a first encrypted email, the email server decrypts the first encrypted email using the public key of the sender and re-encrypts the clear version of the email with the public key of the recipient to generate a second encrypted email. The recipient can decrypt this second encrypted email using the private key stored in the decryption USB device, improving security during email transmission.

According to another embodiment, a mail server as mentioned above is not used to hijack an encrypted email in transit, decrypt it for inspection as an example, and then re-encrypt it to continue the journey of the email. In this case, the encrypted email from the first device 114 is routed to the second device 116 over the network 102.

It should be noted that when a (personal) wearable device is used for the purpose of encrypting/decrypting an email, the wearable device intercepts the email for encryption before the email is sent out. One example is to use a wireless communication (e.g., Bluetooth) to receive the email in a wearable device for encryption and to return the encrypted version back to the first device. Depending on implementation, there are ways to cause an external device such as USB/wearable) to intercept the email for encryption before it is sent out. For example, a pluggable software set, application or midware may be provided to a dedicated mail application (e.g., Outlook or Gmail). A sender may use such an email application to author an email and naturally hit a send button to send out the email. On its way out, the midware is activated to intercept the email and transport it to the external personal device for encryption. The encrypted email is returned back via the midware to the email application, where the email, now encrypted, continues its transit to its designated recipient.

It is understood that an email to a recipient or a file to be exchanged with another user includes or is affixed with an identified destination, for example, an email address or a link to a destination (e.g., a storage location). The destination (address) information is not encrypted to ensure it provides a direction in transit. Accordingly, the personal device used to encrypt the outgoing data (e.g., email or file) is configured to keep the destination data or information clear while encrypting content thereof. The encrypted email goes to the designated destination per the address and is received in an email application at the destination. When a recipient tries to open the email in an email application, the encrypted email is intercepted by a corresponding midware embedded or plugged in the email application. The midware sends the encrypted email to an external personal device of the recipient, where the encrypted email is decrypted in the personal device. The original email (in clear form) is returned to the email application, where the recipient can now view the email.

It should be noted that in all emails as an example, in the present invention, may be from or received in any type of computing devices, such as a desktop computer, a laptop, a tablet, or a mobile phone with email-sending capabilities. A registration server can be a single server or a server cluster, and the same applies to an email server. The registration server or the email server can be the same server or different servers. This embodiment does not limit the specific hardware deployment environment.

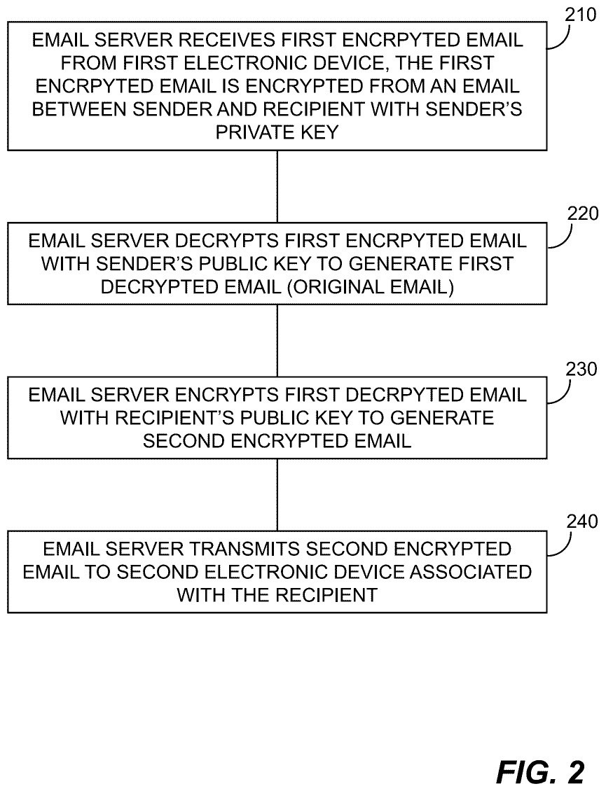

Referring now to FIG. 2, it shows a process or flowchart of a first example method of encrypted email transmission. At 210: An email server receives the first encrypted email sent by the first electronic device. This first encrypted email has been encrypted using a private key associated with a sender who may use a tool to author. In this embodiment, the email server is responsible for transmitting emails between the sender and the recipient. The email server can store both the sender's public key and the recipient's public key. The first electronic device can be any terminal device, such as a computer or mobile phone with email-sending capabilities.

At 220: The email server decrypts the first encrypted email using the public key associated with the sender to generate a first decrypted email. In operation, according to one embodiment, the email server uses the public key, which has been pre-stored, to decrypt the first encrypted email received from the sender or the first electronic device, thereby generating the first decrypted email, namely recovering the original email. There are a number of reasons for the email server or another affiliated server to access the original email. One example is to inspect the email to make sure it is not embedded with a piece of malware or includes an unwanted message/content.

At 230, The email server encrypts the first decrypted email (the original email again) using a public key associated with the recipient to generate a second encrypted email. In operation, after decrypting the first encrypted email to generate the first decrypted email or recover the original email in clear form, the email server uses the pre-stored public key of the recipient to encrypt the first decrypted email again in accordance with the destination or address information in the email, producing a second encrypted email. At 240, the email server sends the second encrypted email to a second electronic device associated with the recipient.

In this embodiment, first and second electronic devices can be any terminal device, such as a computer, laptop, tablet, or mobile phone capable of receiving emails. The first electronic device and the second electronic device can be different electronic devices, or the same device.

According to another embodiment, the email server is not engaged in decrypting and encrypting an email. Similar to a regular email, the email server is configured to mainly route an incoming email, regardless it is encrypted or not, to the destination per the destination information coming with the email.

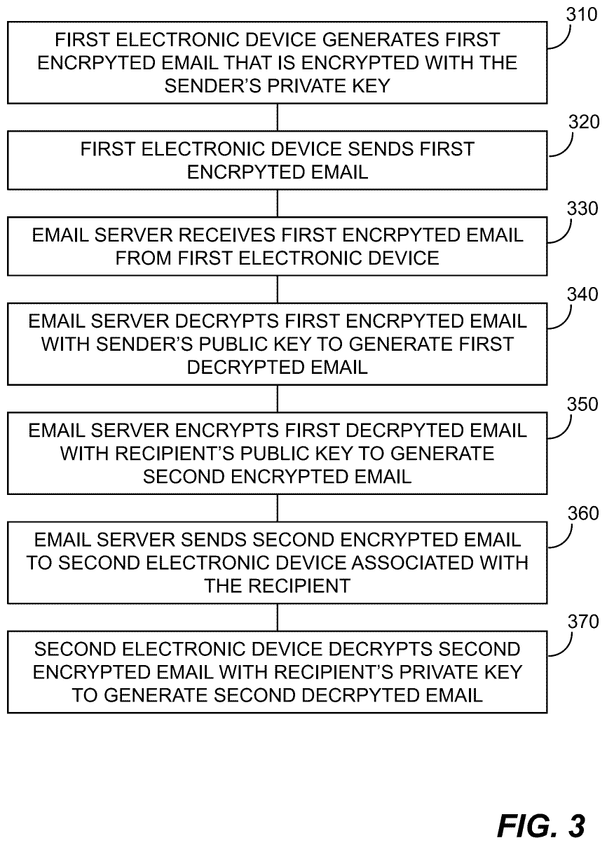

Referring to FIG. 3, it illustrates a processor flowchart of a second example method of encrypted email transmission according to one embodiment. At 310, a first electronic device associated with a sender encrypts an email with a private key associated with the sender to generate a first encrypted email. In this embodiment, before executing 310, the first electronic device coupled to an USB device (e.g., a USB security device physically connects to an electronic device via a USB port). The email is transmitted (e.g., stored or saved) to the encryption USB device, where the encryption USB device using the private key encrypts the email, thus producing a first encrypted email. The first electronic device then retrieves this first encrypted email from the encryption USB device.

At 320, the first electronic device sends out the first encrypted email. Specifically, after retrieving the first encrypted email from the encryption USB device, the first electronic device sends the first encrypted email to an email server over a network. At 330, the email server receives the first encrypted email from the first electronic device. In one embodiment, the email server receives the first encrypted email from the first electronic device associated with the sender and then forwards the email to a second electronic device associate with the recipient. In another embodiment, the email server stores both public keys associated respectively with the sender and the recipient.

At 340, the email server uses the sender's public key to decrypt the first encrypted email, generating a first decrypted email. In operation, the email server uses the pre-stored public key of the sender to decrypt the first encrypted email from the first electronic device, producing a first decrypted email or recovering the. At 350, the email server encrypts the first decrypted email using the public key of the recipient, resulting in a second encrypted email. In operation, after decrypting the first encrypted email, the email server uses the recipient's pre-stored public key to re-encrypt the first decrypted email, producing the second encrypted email.

At 360, the email server sends the second encrypted email to a second electronic device that is associated with the recipient. In this embodiment, the second electronic device can be any terminal device, such as a computer, laptop, tablet, or mobile phone with email receiving functionality. At 370, the second electronic device generates a second decrypted email, which is generated by decrypting the second encrypted email using the recipient's private key. In this embodiment, before executing 370, if a decryption USB device is physically connected to the second electronic device, the second electronic device receives the second encrypted email from the email server. The second encrypted email is then transmitted to the connected decryption USB device, which uses the private key of the recipient to decrypt the second encrypted email, generating a second decrypted email, namely recovering the original email sent by the sender. The second electronic device then retrieves the second decrypted email from the decryption USB device.

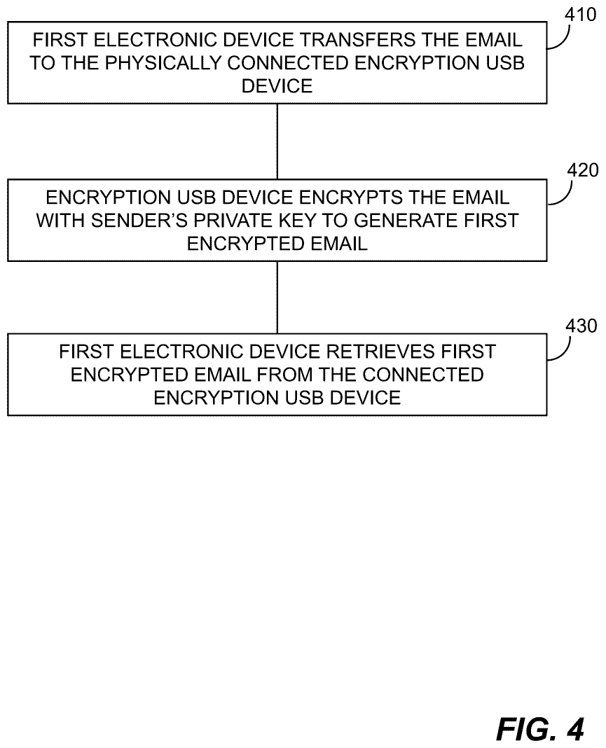

Refer to FIG. 4, it shows a process or flowchart of a third example method of encrypted email transmission. At 410, when an encryption USB device is physically connected to the first electronic device, an email is caused to be transferred to the encryption USB device. In operation, when a computer instruction or command to encrypt and/or send the email is received, the first electronic device detects whether an encryption USB device is physically connected. If an encryption USB device is detected, the email is transferred to the encryption USB device. At 420, the encryption USB device uses a private key of the sender to encrypt the email, generating a first encrypted email. In another embodiment, when a personal device is other than a physically connected USB device, for example, a wearable device, the email is managed to transport to the wearable via a wireless (secured) connection (e.g., Bluetooth), where the email gets encrypted. The encrypted email is returned to the first electronic device to continue its transit to the designated location. In any case, the destination information, such as the email address or a link, is not encrypted to ensure the routing of the email/data is correctly followed.

According to one embodiment, the encryption USB device may be registered with a registration server when connected. After successful registration, the encryption USB device obtains/generates multiple security keys from the registration server, including the private key for the email. At 430, the first electronic device retrieves the first encrypted email from the encryption USB device. In one embodiment, prior to 410, the process also includes the following: detecting whether an encryption USB device is physically connected to the first electronic device in response to an instruction or command for sending the email with encryption; and transferring the email to the connected encryption USB device to get the email encrypted.

In one embodiment, the instruction or command for the encrypted email transmission can be a command chosen by the sender. For example, prior to sending out the email to a designated recipient, the sender can trigger an encryption sending instruction by selecting an option in a menu of various modes to deliver the email. The selected option is to deliver email in encrypted mode. Another way is to embed a midware in an email application (Outlook or Gmail), the midware is activated when an email is sent out. The activated midware intercepts the email and routes it to a personal device (e.g., the USB or a wearable device).

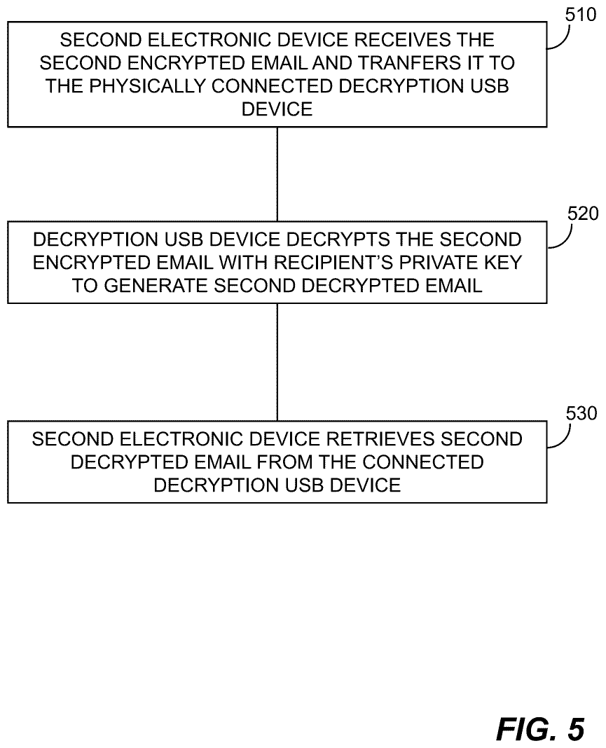

Referring to FIG. 5, it shows a process or flowchart of a fourth example method for encrypted email transmission. It shall be noted that the process of FIG. 5 is needed when the email has to be cleared in an email server. As described above, an incoming encrypted email may be routed to its destination via the email server. The process of FIG. 5 is activated when the encrypted needs to be cleared in the email server.

At 510: when a decryption USB device is connected to a second electronic device, the second electronic device receives the second encrypted email and transmits the second encrypted email to the connected decryption USB device. Specifically, the second electronic device checks whether the decryption USB device is physically connected. If connected, the second encrypted email is transmitted to the connected decryption USB device. In this embodiment, the decryption USB device can be physically connected to the second electronic device. For example, the decryption USB device can be connected to the second electronic device via a USB interface. Correspondingly, the second electronic device can detect whether the decryption USB device is connected by checking the USB interface. The decryption USB device can also be connected via an HDMI or other types of interfaces, and this application does not place specific limitations on the connection method. Similarly, when a wearable or other personal device is used to encrypt an email, a wireless coupling is checked to see if such a device is presence.

At 520, the decryption USB device uses the private key of the recipient to decrypt the second encrypted email, resulting in a second decrypted email (namely the original email from the first electronic device). In this embodiment, prior to 520, the decryption USB device is registered with a registration server when connected to the registration server. After successful registration, the decryption USB device obtains/generates multiple security keys from the registration server, including the private key. The decryption USB device uses the private key to decrypt the second encrypted email, resulting in the second decrypted email. At 530: The second electronic device retrieves the second decrypted email from the physically connected decryption USB device. In this embodiment, when the second electronic device detects that a decryption USB device is physically connected, the second electronic device receives the second encrypted email from the email server. Then the second electronic device transfers the second encrypted email to the connected decryption USB device. The decryption USB device then decrypts the second encrypted email using the recipient's private key to generate a second decrypted email, thereby enhancing the security of the email during transmission between the email server and the second electronic device. The second electronic device retrieves the second decrypted email (i.e., original content of the mail) from the connected decryption USB device and presents the second encrypted email to the recipient.

In one embodiment, prior to 520, the decryption USB device is registered with a registration server while connected to the registration server. After successful registration, the decryption USB device obtains/generates multiple security keys from the registration server, including the recipient's private key. When in registration, a personal device or the decryption USB device can register using a name, an email address, and other verified information. Upon successful registration with the registration server, the decryption USB device obtains/generates multiple security keys from the registration server, including the recipient's private key.

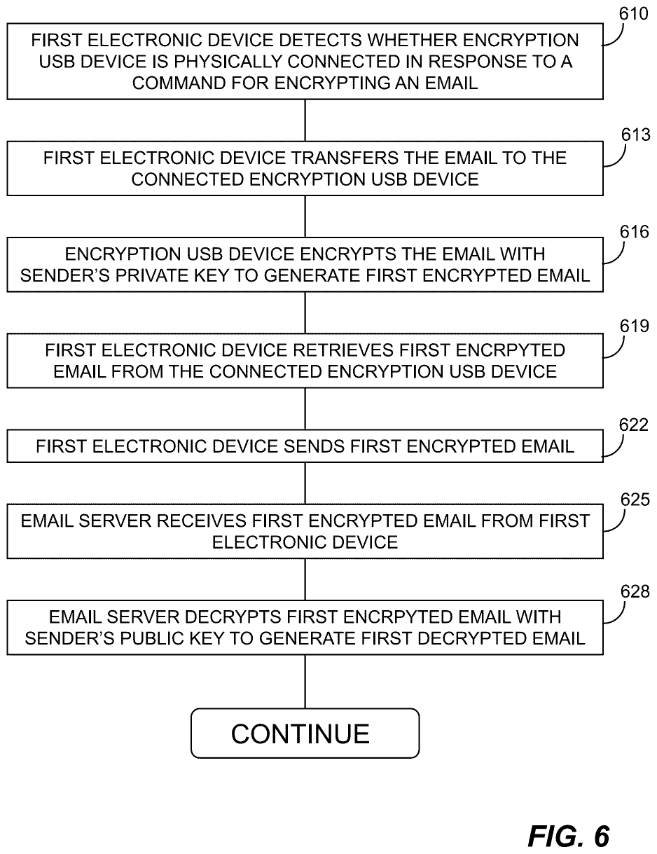

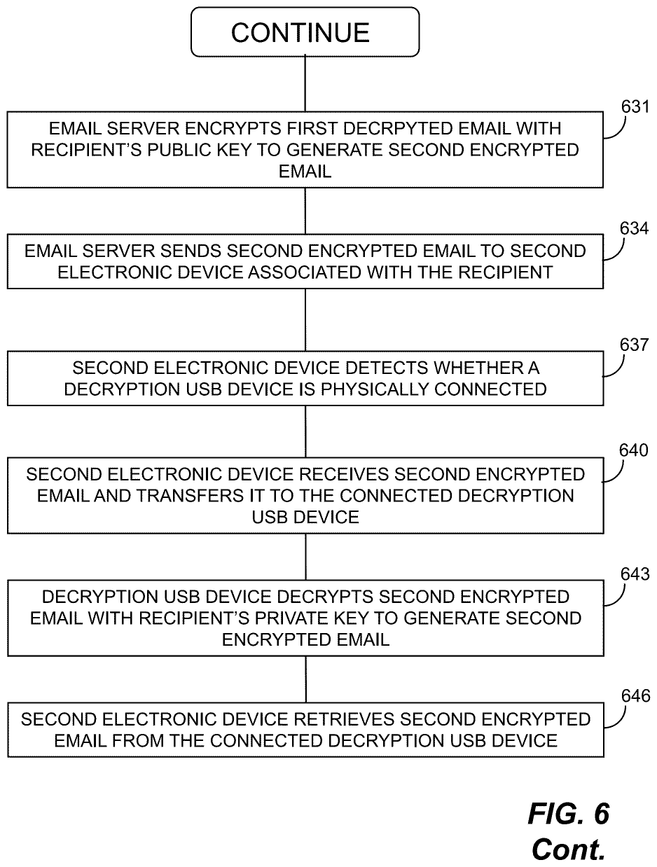

Referring to FIG. 6, it shows a flowchart or method of encrypted email transmission. As shown in FIG. 6, the method includes the following steps: Step 610: The first electronic device detects whether an encryption USB device is physically connected in response to an instruction or command for encrypted email transmission. In the embodiment, the instruction or command for the encrypted email transmission can be a command chosen by the sender. Specifically, for example, prior to transferring the email to the connected encryption USB device, the sender can trigger the encryption sending instruction by selecting an option in a menu of various modes to deliver the email. The selected option is to deliver email in encrypted mode. Other feasible delivery modes may be listed in the menu. The first electronic device, in response to receiving the instruction or commend for encrypted email transmission, checks whether the encryption USB device is physically connected to the first electronic device.

In this embodiment, the encryption USB device can be physically connected to the first electronic device. For example, the encryption USB device may be connected to the first electronic device via a Universal Serial Bus (USB) interface. Accordingly, the first electronic device can detect the presence of the encryption USB device by checking the USB interface. The encryption USB device may also be connected through an HDMI (High-Definition Multimedia Interface) or other types of interfaces, and this application does not limit the specific interface type. Step 613: If the encryption USB device is physically connected to the first electronic device, the email is transferred to the encryption USB device. Step 616: The encryption USB device uses the sender's private key to encrypt the email, resulting in a first encrypted email.

In this embodiment, the encryption USB device is registered with a registration server when connected to the registration server. After successful registration, the encryption USB device obtains/generates multiple security keys from the registration server, including the sender's private key. The encryption USB device encrypts the email using the sender's private key to generate a first encrypted email.

In this embodiment, the encryption USB device can register using the sender's name, email address, and other information. After successful registration with the registration server, the encryption USB device obtains/generates multiple security keys from the email server, including the sender's private key.

Step 619: The first electronic device retrieves the first encrypted email from the connected encryption USB device. Step 622: The first electronic device sends the first encrypted email. Specifically, after retrieving the first encrypted email from the encryption USB device, the first electronic device sends the first encrypted email to an email server. Step 625: The email server receives the first encrypted email sent by the first electronic device.

In this embodiment, the email server is a dedicated email server responsible for receiving the first encrypted email from the first electronic device associated with the sender; and for sending the second encrypted email to a second electronic device associated with the recipient. Furthermore, the email server stores the public key of the sender and the public key of the recipient. Step 628: The email server decrypts the first encrypted email using the public key of the sender to generate the first decrypted email. Specifically, the email server uses the pre-stored public key of the sender to perform the email decryption operations on the first encrypted email received from the first electronic device, generating the first decrypted email.

Step 631: The email server encrypts the first decrypted email using the public key of the recipient to generate a second encrypted email. Specifically, after decrypting the first encrypted email to generate the first decrypted email, the email server uses the pre-stored public key of the recipient to re-encrypt the first decrypted email, generating the second encrypted email. Step 634: The email server sends the second encrypted email to a second electronic device associated with the recipient. In this embodiment, the second electronic device can be any terminal device, such as any computer, laptop, tablet, or mobile device with email receiving capabilities. Step 637: The second electronic device detects whether a decryption USB device is physically connected.

In this embodiment, the decryption USB device can be connected to the second electronic device via physical connection. For example, the decryption USB device can be connected to the second electronic device through a universal serial bus (USB) interface. Accordingly, the second electronic device can detect the presence of the decryption USB device by checking the USB interface. The decryption USB device can also be connected to the second electronic device via a high-definition multimedia interface (HDMI) or other types of interfaces. This is not specifically limited in this application.

Step 640: If a decryption USB device is physically connected to the second electronic device, the second electronic device receives the second encrypted email and transfers it to the connected decryption USB device. Step 643: The decryption USB device decrypts the second encrypted email using the recipient's private key, generating a second decrypted email. In this embodiment, before executing step 643, the decryption USB device is registered with a registration server while connected to the registration server. Upon successful registration, the decryption USB device obtains/generates multiple security keys from the registration server, including the private key of the recipient. The decryption USB device uses the recipient's private key to decrypt the second encrypted email, generating a second decrypted email. For example, the decryption USB device can be registered with a registration server using a (recipient) name, email address, and other information. After successfully registering with the registration server, the decryption USB device obtains/generates multiple security keys from the registration server, including the private key of the recipient of the second encrypted email. Step 646: The second electronic device retrieves the second decrypted email from the decryption USB device.

In this embodiment, the first electronic device sends the first encrypted email to the email server. The email server decrypts the first encrypted email with the sender's public key to generate the first decrypted email. Then, the email server re-encrypts the first decrypted email using the recipient's public key to generate a second encrypted email. This process improves the security of the email during transmission. The email server then sends the second encrypted email to a second electronic device associated with the recipient.

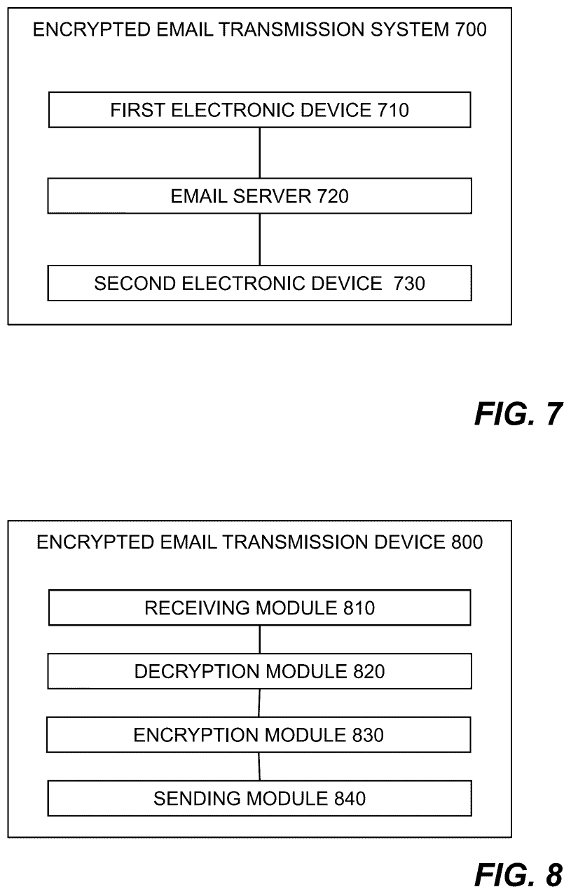

FIG. 7 is an exemplary structural block diagram of an encrypted email transmission system including: a first electronic device 710, an email server 720, and a second electronic device 730. The first electronic device 710 is used for generating the first encrypted email. The first electronic device 710 encrypts the email using the sender's private key to generate the first encrypted email and then sends the first encrypted email to the email server 720.

The email server 720 is used for receiving the first encrypted email; for decrypting the first encrypted email using the sender's public key to generate a first decrypted email; and for encrypting the first decrypted email using the recipient's public key to generate a second encrypted email. The email server sends the second encrypted email to a second electronic device 730 that is associated with the recipient. The second electronic device 730 is used for generating the second decrypted email, namely decrypting an encrypted email using the recipient's private key.

The encrypted email transmission system 700 enhances the security of the email transmission by encrypting the first encrypted email with the sender's private key during transmission from the first electronic device 710 to the email server 720. Additionally, the second encrypted email is encrypted with the recipient's public key during its transmission from the email server 720 to the second electronic device 730. By using different security keys for encryption and decryption in these two stages, the security of the email transmission is greatly enhanced or improved, addressing the security issues during email transmission.

The encrypted email transmission system 700 also includes an encryption USB device. The first electronic device 710, while generating the first encrypted email, transfers the email to the encryption USB device when the encryption USB device is physically connected. The encryption USB device encrypts the email using the sender's private key, resulting in the first encrypted email.

Prior to transferring the email to the encryption USB device, the first electronic device 710 detects whether the encryption USB device is physically connected in response to an instruction or command for encrypted email transmission. Prior to encrypting the email in the encryption USB device, the first electronic device 710 transfers the email to a physically connected encryption USB device. Prior the using the sender's private key to encrypt the email, the encryption USB device is registered with a registration server when connected to the registration server. After successful registration, the encryption USB device obtains/generates multiple security keys from the registration server, including the sender's private key.

The encrypted email transmission system 700 also includes a decryption USB device. The second electronic device 730, while generating the second decrypted email, receives the second encrypted email from the email server 720, when the decryption USB device is physically connected. The decryption USB device decrypts the second encrypted email using the recipient's private key, generating the second decrypted email. Prior to using the recipient's private key to decrypt the second encrypted email, the decryption USB device is registered with a registration server when connected to the registration server. After successful registration, the decryption USB device obtains/generates multiple security keys from the registration server, including the recipient's private key.

FIG. 8 is a structural block diagram of an example encrypted email transmission device. Referring to FIG. 8, the example encrypted email transmission device 800 includes a receiving module 810 for receiving an email sent by a first electronic device, a decryption module 820 for decrypting an encrypted email, an encryption module 830 for encrypting an email, and a sending module 840 for sending an encrypted email to a second electronic device associated with a designated recipient. It shall be noted that the decryption module 820 and the encryption module 830 work alternatively, which means the encryption module 830 encrypts a clean email when the decryption module 820 decrypts an encrypted email. Despite the data flowing shown in FIG. 8, one only works at a time for an incoming (clear or encrypted) mail. In any case, both exist in a personal device, such as a USB drive.

When intercepting or receiving a clear email for encryption, the sender's private key is used to encrypt the email for transmission over a network. Not always the case, a mail server decrypts the encrypted email and uses the recipient's public key to encrypt the clear email again (second encrypted email) to continue the journey of the email to the second electronic device. By using different keys for encryption and decryption in these two processes, the security of the email transmission is greatly enhanced or improved, addressing the issue of low security during email transmission.

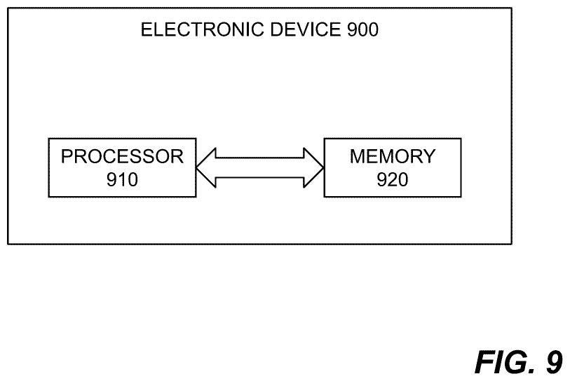

As shown in FIG. 9, it is a function block diagram of an example electronic device 900, which can be various types of computers, etc. The electronic device 900 can serve as an email server. The electronic device 900 includes: a processor 910 and a memory 920, where the memory 920 stores programs or instructions that, when executed by the processor 910, implement the steps of any of the methods described herein. For example, when a program is executed by the processor 910, the following process is implemented: receiving the first encrypted email sent by the first electronic device, where the first encrypted email is encrypted using the sender's private key; decrypting the first encrypted email using the sender's public key to generate a first decrypted email; encrypting the first decrypted email using the recipient's public key to generate a second encrypted email; and sending the second encrypted email to a second electronic device associated with the recipient. In this way, the sender's private key is used to encrypt the email during the transmission of the first encrypted email from the first electronic device to the email server, enhancing the security of the email transmission. Meanwhile, the recipient's public key is used to encrypt the second encrypted email during its transmission from the email server to a second electronic device associated with the recipient, improving or enhancing the security of the email transmission. By using different keys for encryption and decryption in these two processes, the security of the email transmission is greatly improved, addressing the issue of low security during email transmission.

This embodiment also provides a readable storage medium, on which programs or instructions are stored. When executed by the processor, these programs or instructions implement the steps of the operation and maintenance script execution method provided in any of the embodiments above, and achieve the same technical effect. To avoid repetition, this will not be elaborated here. The processor mentioned here refers to the processor in the electronic device described in the above embodiments. The readable storage medium includes non-transitory computer-readable storage media, such as computer read-only memory (ROM), random-access memory (RAM), magnetic disks, or optical discs, etc.

The electronic device 900 can be a semi-conductor chip that includes a processor and a communication interface. The communication interface is coupled to the processor, and the processor is used to execute programs or instructions to implement the various processes of the example methods described above and achieve the same technical effects. To avoid repetition, it is not be elaborated here.

This embodiment of the application provides a computer program product, which is stored in a storage medium. The program product is executed by at least one processor to implement the various processes of the method embodiments described above and achieve the same technical effects. To avoid repetition, this will not be elaborated here.

It should be noted that the terms “comprise,” “include,” or any variations thereof are intended to encompass non-exclusive inclusion, so that a process, method, article, or apparatus that includes a series of elements not only includes those elements but may also include other elements that are not explicitly listed or inherent to the process, method, article, or apparatus. Without further restrictions, elements defined by the statement “comprise one . . . ” do not exclude the possibility that other identical elements exist in the process, method, article, or apparatus that includes that element. Furthermore, it should be pointed out that the scope of the methods and apparatus in the embodiments of this application is not limited to performing functions in the order shown or discussed. The functions can also be performed simultaneously or in reverse order, depending on the involved functions. For example, the described methods can be performed in an order different from the one described, and steps can be added, omitted, or combined. Additionally, features described with reference to certain examples can be combined in other examples.

Through the description of the above embodiments, those skilled in the art can clearly understand that the methods described in the embodiments can be implemented by software in combination with necessary general-purpose hardware platforms, although it can also be implemented by hardware in many cases. However, the former is often a better implementation. Based on this understanding, the technical solutions of this application can essentially be reflected in the form of a computer software product. This computer software product is stored on a storage medium (such as ROM/RAM, magnetic disk, or optical disk) and includes several instructions that enable a terminal (which can be a mobile phone, computer, server, or network device, etc.) to execute the methods described in the various embodiments of this application.

The above descriptions of the embodiments have been presented in conjunction with the accompanying figures, but the application is not limited to the specific implementations described. The described implementations are merely illustrative and not restrictive. Ordinary technicians in the field, based on the insights provided by this application, can make many variations without departing from the spirit and scope of the claims, all of which fall within the protection scope of this application.

What is claimed is:

1. A method for secured email transmission, the method comprising:
generating an encrypted email in a first personal device associated with a sender of an email, wherein the first personal device of the sender includes a cipher engine encrypting the email, the first personal device and the first personal device are two different devices;
transporting the encrypted email over a network; and
recovering the email from the encrypted email when the encrypted email is received, wherein the email is decrypted by a cipher engine in a second personal device associated with a recipient, the second personal device and the second personal device are two different devices.

2. The method as recited in claim 1, wherein both of the first and second personal devices are portable.

3. The method as recited in claim 2, wherein either of the first and second personal devices is in form of a USB drive.

4. The method as recited in claim 2, wherein the cipher engine in the first personal device corresponds to the cipher engine in the second personal device.

5. The method as recited in claim 1, wherein said generating an encrypted email in a first personal device associated with a sender of an email comprises:
receiving the email authored in a first email application;
hijacking the email on way out from the first email application; and
encrypting the email to generate the encrypted email.

6. The method as recited in claim 5, wherein said recovering the email from the encrypted email comprises:
receiving the encrypted email in a second email application;
hijacking the encrypted email when the second email application is attempted to open the encrypted email; and
decrypting the encrypted email to recover the email.

7. The method as recited in claim 1, wherein said transporting the encrypted email over a network comprises:
routing the encrypted email to a mail server;
decrypting the encrypted email in the mail server using a public key associated with the sender to generate a temporary email;
encrypting the temporary email to reproduce the encrypted email; and
continuing to route the encrypted email to the recipient.

8. The method as recited in claim 7, wherein the temporary email is only accessed by authorized personnel know or unknown to the sender or recipient.

9. The method as recited in claim 7, wherein the temporary email is scanned for a predefined purpose.

10. A system for secured email transmission, the system comprising:
a first personal device including a cipher engine provided to encrypt an email authorized by a sender when the email is ready to be transported over a network to a recipient, wherein the first personal device is associated with the sender;
a second personal device including a cipher engine provided to decrypt an encrypted email when the encrypted email is received from the network, wherein the second personal device is associated with the recipient.

11. The system as recited in claim 9, further comprising:
a mail server receiving the encrypted email and routing the encrypted email to the recipient in accordance with an email address affixed to the encrypted email.

12. The system as recited in claim 9, further comprising:
a mail server receiving the encrypted email, decrypting the encrypted email to generate a temporary email, encrypt the temporary email to reproduce the encrypted email and subsequently route the encrypted email to the recipient in accordance with an email address affixed to the encrypted email.

13. The system as recited in claim 12, wherein the mail server decrypts the encrypted email using a public key associated with the sender to generate the temporary email.

14. The system as recited in claim 13, wherein the mail server encrypts the temporary email using a public key associated with the recipient to reproduce the encrypted email.

15. The system as recited in claim 12, wherein the mail server is within an organization associating with the first and second personal devices.

16. The system as recited in claim 12, wherein either of the first and second personal devices is portable.

17. The system as recited in claim 16, wherein each of the first and second personal devices is a USB drive.
